(19) United States
(12) Patent Application Publication
(10) Pub. No.: US 2025/0165939 A1
(43) Pub. Date: May 22, 2025

(54) SYSTEMS AND METHODS FOR REGULATING ACCESS TO DATA STORED IN A DATA SOURCE

(71) Applicant: MasterCard International Incorporated, Purchase, NY (US)

(72) Inventors: David J. Senci, Troy, IL (US); Sharon Amy Rosano, New Canaan, CT (US); John D. Chisholm, Ballwin, MO (US); Peter Groarke, Dublin (IE)

(21) Appl. No.: 19/029,991

(22) Filed: Jan. 17, 2025

Related U.S. Application Data
(63) Continuation of application No. 15/331,538, filed on Oct. 21, 2016, now abandoned.

(51) Int. Cl. G06Q 20/10; G06F 21/62; G06Q 20/34; G06Q 20/40; G06Q 30/04

(52) U.S. Cl. CPC G06Q 20/102; G06F 21/6245; G06Q 20/34; G06Q 20/401; G06Q 20/4016; G06Q 20/4018; G06Q 30/04

(57) ABSTRACT

A regulated computing device for regulating an information data source and verifying access to the information data source is provided. The regulated computing device receives account data from an issuer, the account data corresponding to a cardholder, and stores the account data in the information data source based on an account identifier associated with the cardholder. The regulated computing device receives an update request from a merchant, the update request including the account identifier and requesting the account data of the cardholder, and verifies the update request in response to receiving the update request by applying at least one verification rule and determining that the merchant is a verified merchant. The regulated computing device also generates an update response, the update response including the account data of the cardholder, and transmits the update response to the verified merchant.

### CROSS-REFERENCE TO RELATED APPLICATIONS

This application is a continuation of U.S. Patent Application application Ser. No. 15/331,538, filed Oct. 21, 2016, entitled “SYSTEMS AND METHODS FOR REGULATING ACCESS TO DATA STORED IN A DATA SOURCE,” the entire contents of which are hereby incorporated herein by reference in its entirety.

### BACKGROUND

The field of the disclosure relates generally to regulating access to data stored in a data source, and more particularly, to systems and methods for verifying message queries submitted to a data source such as an account-on-file billing updater (ABU) system.

Electronic data is typically stored within databases. The databases can be accessed by different people using computing devices coupled in communication with the databases. However, in some cases the data stored within the databases must be kept secure, such that only those people that are approved to access the data are actually able to access the data. Accordingly, systems are deployed that regulate access to the data.

The payment card industry is a good example where data stored within certain databases is kept secured. For example, the payment card industry includes payment transactions wherein a payment cardholder makes a purchase, but the physical payment card is not present. These transactions are known as “card-not-present” (CNP) transactions. In such transactions, information regarding the payment card, including an account number and, in many instances, an expiration date for the payment card is transmitted from a merchant, along with an indicator that the transaction is a CNP transaction. An “account-on-file” transaction is another type of transaction in which the merchant stores information regarding the cardholder's payment card in a database, then retrieves the stored payment card information and includes it in a payment authorization request. One specific type of account-on-file transaction is a “recurring payment transaction,” which a merchant initiates on a recurring basis for a particular cardholder. In such recurring payment transactions, the merchant stores information regarding the cardholder's payment card in a database, then retrieves the stored payment card information and includes it in each recurring authorization request.

An example of a recurring card-on-file payment transaction is a gym membership. Rather than mailing a monthly check for membership with a gym, a cardholder might choose to register a payment card, such as a credit card, a debit card, or a prepaid card, with the gym. Registering the payment card with the gym enables the gym to automatically charge the payment card for the monthly dues on a particular day each month. In some such systems, the merchant stores an account number, an expiration date, and/or other information associated with the payment card and/or cardholder. Given the convenience of this payment model for both merchants and cardholders, it finds use in many other scenarios where a cardholder is a member of a club or subscriber of products or services. Accordingly, multiple merchants may have stored payment card information for the same cardholder. Likewise, any given merchant may have stored payment card information for multiple cardholders.

In addition to recurring payment transactions, merchants may also maintain account-on-file information to facilitate payment card transactions by repeat customers. For example, an online merchant may allow a shopper to create an online account and store account information corresponding to one or more methods of payment. When the shopper is ready to check out and complete a purchase, the shopper may simply select one of the stored payment methods as opposed to having to re-enter their payment card information.

A downside of storing payment card information, however, is that information regarding a payment card is subject to change. For example a cardholder's payment card might expire, causing a new payment card to be issued with a new expiration date while the card number remains the same. In such instances, an authorization request containing the outdated expiration date is denied by the issuer of the payment card. As a result, the merchant who originally submitted the authorization request is prevented from successfully obtaining payment until the merchant acquires the updated expiration date for the payment card. Due to wide adoption of the account-on-file payment model by merchants and cardholders, it is understandably difficult for a cardholder to update each merchant with new payment card expiration dates. Likewise, it reduces the benefits of the account-on-file payment model to require a merchant to inquire with each cardholder for an updated payment card expiration date prior to submitting each payment authorization request.

In light of the foregoing, at least some known systems may provide merchants with updated cardholder payment card information. However, to obtain the updated account information in such systems, a merchant must submit an account query corresponding to one or more payment card accounts to the merchant's acquiring bank which then forwards the message query to a central account information system. In response to the query, the account information system retrieves corresponding account information received from an issuer and transmits the retrieved account information to the acquiring bank. The acquiring bank may then forward the retrieved account information to the merchant, which may then update its database of account-on-file payment card information.

These known systems are limited in several ways. For example, these known systems do not provide monitoring of the received merchant account queries. In these known systems, as long as the acquiring bank registers the merchant with the central system, the merchant may submit an account query and receive updated account information, even on account information that has not been registered and authorized by the cardholder with the merchant. This may lead to fraud issues. Similarly, these known systems do not police the submitted merchant account queries for flagged merchants that are potentially fraudulent and/or knowingly fraudulent. Also, these known systems do not provide for issuer feedback to merchants. As such, issuers are dissuaded from signing-up for these systems. In light of the foregoing, an enhanced account information system is needed, wherein the enhanced system address these problems and others.

### BRIEF DESCRIPTION OF THE DISCLOSURE

In one aspect, a regulated account-on-file billing updater (ABU) computing device is disclosed. The regulated ABU computing device includes one or more processors in communication with one or more memory devices and is configured to: receive current account data from an issuer, the current account data corresponding to a cardholder; store the current account data in an account information data source based on an account identifier associated with the cardholder; receive an update request from a merchant, the update request including the account identifier and requesting the current account data of the cardholder; verify the update request upon receiving the update request by applying at least one verification rule and determining that the merchant sending the update request is a verified merchant authorized to receive the current account data; generate an update response, the update response including the current account data of the cardholder; and transmit the update response to the verified merchant.

In a second aspect, a computer-implemented method for verifying account-on-file information is provided. The method is implemented using a regulated ABU computing device in communication with one or more memory devices. The method includes: receiving current account data from an issuer, the current account data corresponding to a cardholder; storing the current account data in an account information data source based on an account identifier associated with the cardholder; receiving an update request from a merchant, the update request including the account identifier and requesting the current account data of the cardholder; verifying the update request upon receiving the update request by applying at least one verification rule and determining that the merchant sending the update request is a verified merchant authorized to receive the current account data; generating an update response, the update response including the current account data of the cardholder; and transmitting the update response to the verified merchant.

In yet another aspect, a computer-readable storage medium having computer-executable instructions embodied thereon is provided. When executed by a regulated ABU computing device having at least one processor in communication with at least one memory device, the computer-executable instructions cause the regulated ABU computing device to: receive current account data from an issuer, the current account data corresponding to a cardholder; store the current account data in an account information data source based on an account identifier associated with the cardholder; receive an update request from a merchant, the update request including the account identifier and requesting the current account data of the cardholder; verify the update request in response to receiving the update request by applying at least one verification rule and determining that the merchant sending the update request is a verified merchant authorized to receive the current account data; generate an update response, the update response including the current account data of the cardholder; and transmit the update response to the verified merchant.

### BRIEF DESCRIPTION OF THE DRAWINGS

FIGS. 1-4 show example embodiments of the methods and systems described herein.

FIG. 1 is a schematic diagram illustrating a payment platform having a regulated account-on-file billing updater (ABU) computing device.

FIG. 2 is a diagram illustrating a regulated ABU system including the regulated ABU computing device shown in FIG. 1, in communication with the payment processing system of FIG. 1.

FIG. 3 is a diagram illustrating an example of the regulated ABU computing device shown in FIGS. 1 and 2.

FIG. 4 is a flow chart illustrating an example method for verifying account-on-file information using the regulated ABU computing device shown in FIGS. 1 and 2 in accordance with one example embodiment of the present disclosure.

### DETAILED DESCRIPTION OF THE DISCLOSURE

The systems and methods described herein are directed to an account-on-file billing updater (ABU) computing device for validating update requests submitted by merchants. This enhanced ABU computing device is referred to herein as a regulated ABU computing device.

In general, the regulated ABU computing device receives account data from one or more issuers and maintains the account data in an account information data source. The regulated ABU computing device may then receive update requests from requesting parties, which may include one or more merchants. The regulated ABU computing device then validates the update request using one or more validation rules. Based on the authorization, the regulated ABU computing device may allow the update request and return an update response containing the requested data, or the regulated ABU computing device may block the update request and return an update response containing a denial. Throughout this process, the regulated ABU computing device may record update request data. Additionally, the regulated ABU computing device may receive verification rules and also fraud information data for accounts and merchants. In certain embodiments, the regulated ABU computing device may also generate and transmit reports based on the verification rules applied.

The regulated ABU computing device periodically receives account data from one or more issuers and maintains the account data in an account information data source. If a merchant wishes to update its account data, the requesting party may submit an update request to the regulated ABU computing device. In certain embodiments, multiple update requests from one or more merchants may be collected and submitted to the regulated ABU computing device as a batch. For example, an acquirer may collect multiple update requests from one or more merchants and submit the update requests as a batch to the regulated ABU computing device.

In response to receiving the update request, the regulated ABU computing device may look up or otherwise retrieve account data from the account information data source. In certain embodiments, account data stored in the account information data source may be stored based on account identifiers and update requests may include one or more account identifiers for which the requesting party is requesting updated account data. To facilitate policing of the currently unregulated update requests, the regulated ABU computing device may then verify the update request by applying at least one verification rule and determining that the merchant sending the update request is a verified merchant authorized to receive the account data. Based on the verification, the regulated ABU computing device may allow the update request and return an update response containing the updated account data that is transmitted to the requesting party. Or, the regulated ABU computing device may block the requester's update request and generate an update request with a denial stating that the update request is blocked. When the update request is blocked the update denial may also provide reason(s) as to why the blocking occurred. In either situation the generated update response may also be transmitted to the issuer and/or to the merchant.

To facilitate policing of the merchant update requests, the regulated ABU computing device may receive the verification rules from the issuer. As such, the issuer may specify to the regulated ABU computing device allowed merchant behavior and/or provide certain predetermined conditions for allowing merchant update requests. In other embodiments, the regulated ABU computing device may discontinue merchant enrollment within the regulated ABU system if a predetermined activity occurs. For example, the regulated ABU computing device may automatically discontinue merchant enrollment if there is no system activity for six (6) months.

In some embodiments, the issuer may have different verification rules for specific account ranges. For example, different verification rules may be applied to high net worth accounts as compared to average net worth accounts, which may be identified by an issuer bank identification number (BIN). The BIN may be provided by the issuer with the account data and received by the regulated ABU computing device. The regulated ABU computing device may then verify the merchant update request using the verification rules selected from a set of verification rules based on the provided BIN. For example, based on the BIN, at least one range of accounts may verify the merchant update request by determining whether the merchant has prior approved transactions corresponding to the account identifier. If there are prior approved transactions corresponding to the account identifier from the merchant, the merchant is verified and the update request is allowed. In another example, the regulated ABU computing device may determine whether the update request was received beyond a predetermined time period since a last approved transaction corresponding to the account identifier. If the last update request is more than a predetermined time period, the merchant is not-verified and the update request is blocked.

The verification rules for the ABU computing device may also be derived from merchant fraud data received from a fraud monitoring source, such as MasterCard® System to Avoid Fraud Effectively (SAFE), MasterCard Expert Monitoring System® (EMS), or any other fraud monitoring source (MasterCard and MasterCard Expert Monitoring System are both registered trademarks of MasterCard International Incorporated located in Purchase, New York) (SAFE and EMS are fraud monitoring products that are offered by MasterCard). The regulated ABU computing device receives the merchant fraud data from the fraud monitoring source that may include chargeback data and common point data. In certain embodiments, the regulated ABU computing device verifies the merchant update request using verification rules derived from the merchant fraud data. For example, the verification rules may include determining whether a fraud chargeback count derived from the merchant fraud data exceeds a predetermined fraud chargeback count limit. If the fraud chargeback count for that merchant exceeds the predetermined fraud chargeback count limit, the merchant is non-verified and the update request is blocked. In another example, the regulated ABU computing device may determine whether a fraud chargeback percentage derived from the merchant fraud data exceeds a predetermined fraud chargeback percent limit. If the fraud chargeback percentage for the merchant exceeds the predetermined fraud chargeback percent limit, the merchant is non-verified and the update request is blocked. In a further example, the regulated ABU computing device may also determine whether the merchant is a common point of fraud, and if so, the merchant is non-verified and the merchant update request is blocked.

The verification rules for the regulated ABU computing device may further be derived from account fraud data received from the fraud monitoring source, similar to the fraud monitoring sources listed above. The regulated ABU computing device receives account fraud data from the fraud monitoring source that may include chargeback data, transaction data, average transaction data, and blacklist data. In certain embodiments, the regulated ABU computing device verifies the merchant update request using verification rules derived from the account fraud data. For example, the verification rules may include determining whether the account identifier has a predetermined fraud indicator. If the account identifier has a predetermined fraud indicator then the merchant is non-verified and the merchant update request is blocked. In another example, the regulated ABU computing device determines whether the account identifier is on an account blacklist. If the account identifier is on the account blacklist then the merchant is non-verified and the merchant update request is blocked. In a further example, the verification rules determines whether a date of the account identifier exceeds a predetermined date limit, such that old account identifier cannot be updated by the merchant. For example, account identifiers more than fifty (50) months old may not be updated by the merchant and the merchant is determined to be non-verified.

In other embodiments, the verification rules for the regulated ABU computing device include receiving merchant feedback data received from an authorization request message corresponding to a payment card transaction between the merchant and the issuer. With the payment card transaction, an advice code is typically included that provides instructions from the issuer to the merchant. For example the issuer may request that the merchant stop maintaining the cardholder's account-on-file information. If so, the regulated ABU computing device can store this information and use it to verify the merchant update request. For example, the verification may include determining whether a feedback actioned count derived from the stored advice codes exceeds a predetermined feedback action count limit. If the feedback actioned count exceeds the predetermined feedback action count limit, the merchant is non-verified and the update request is blocked. In another example, the regulated ABU computing device may determine whether a feedback actioned percentage derived from the stored advice codes exceeds a predetermined verification feedback actioned percentage limit. If the feedback actioned percentage for the merchant exceeds the predetermined feedback actioned percentage limit, the merchant is non-verified and the update request is blocked.

In yet other embodiments, the issuer provides a merchant black list to the regulated ABU computing device that receives and stores the merchant black list. The verification rules may further include determining whether the merchant is on the merchant black list, and if so, the merchant is determined to be non-verified and the update request is blocked.

The methods and systems described herein may be implemented using computer programming or engineering techniques including computer software, firmware, hardware or any combination or subset thereof, wherein the technical effect is achieved by performing at least one of: (a) receiving current account data from an issuer, the current account data corresponding to a cardholder; (b) storing the current account data in an account information data source based on an account identifier associated with the cardholder; (c) receiving an update request from a merchant, the update request including the account identifier and requesting the current account data of the cardholder; (d) verifying the update request upon receiving the update request by applying at least one verification rule and determining that the merchant sending the update request is a verified merchant authorized to receive the current account data; (e) generating an update response, the update response including the current account data of the cardholder; and (f) transmitting the update response to the verified merchant.

The systems and methods described herein provide the technical advantages of (a) reducing the likelihood that account-on-file payment card transactions will be fraudulent; (b) identifying and blocking merchant update requests that are likely fraudulent, similarly reducing up-to-date account information from being disseminated; (c) controlling and policing access to ABU systems; and (d) increasing issuer participation in ABU systems.

### Example of Payment Card Transaction Network

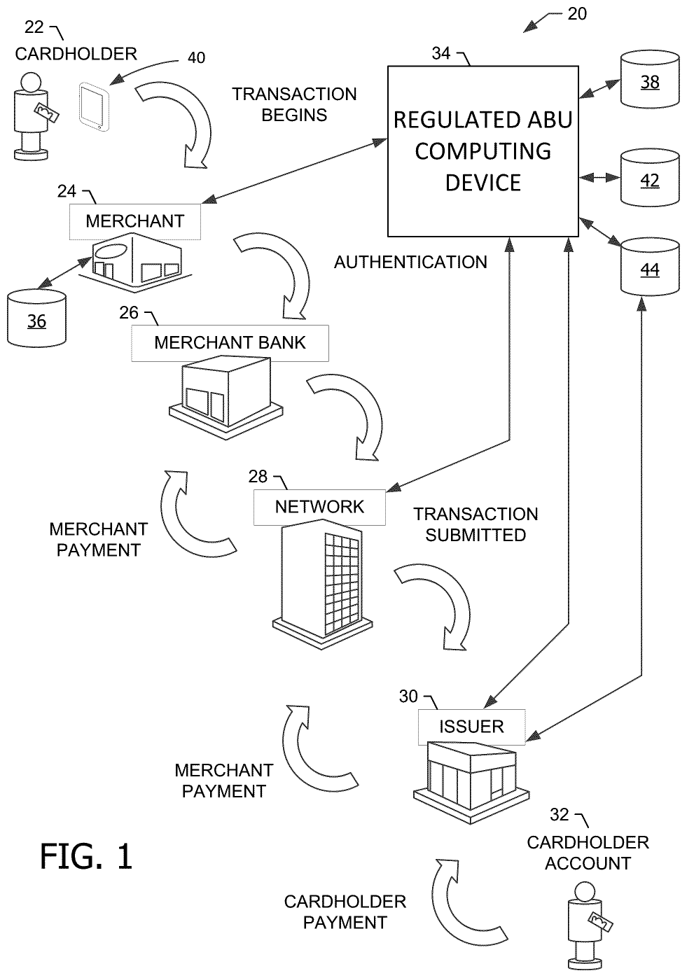

FIG. 1 is a schematic diagram illustrating a payment platform 20 that includes an account-on-file billing updater (ABU) computing device 34. Embodiments described herein may relate to a transaction card system, such as a payment card payment system using the MasterCard® interchange network. The MasterCard® interchange network is a set of proprietary communications standards promulgated by MasterCard International Incorporated for the exchange of financial transaction data and the settlement of funds between financial institutions that are associated with MasterCard International Incorporated.

In a typical transaction card system, a financial institution referred to as the “issuer” issues a transaction card, such as a credit card, debit card, and the like, to the consumer or accountholder 22, who uses the transaction card to tender payment for a purchase from merchant 24. To accept payment with the transaction card, merchant 24 normally establishes an account with a financial institution that is part of the financial payment system. This financial institution is referred to as the “merchant bank,” the “acquiring bank,” or the “acquirer.” In one embodiment, accountholder 22, also referred to as cardholder, tenders payment for a purchase using a transaction card at a transaction processing device 40 (e.g., a point of sale device), and merchant 24 then requests authorization from a merchant bank 26, also referred to as a merchant processor, for the amount of the purchase. The request is usually performed through the use of a point-of-sale terminal, which reads account information from a magnetic stripe, a chip, embossed characters, and the like, included on the transaction card of the accountholder 22 and communicates electronically with the transaction processing computers of merchant bank 26. In the context of transactions with online merchants, an accountholder 22 may provide their account information, such as their account number, a card verification number, an expiration date, and the like through a website. Alternatively, merchant bank 26 may authorize a third party to perform transaction processing on its behalf. In this case, the point-of-sale terminal may be configured to communicate with the third party. Such a third party may be referred to as a “merchant processor,” an “acquiring processor,” or a “third party processor.”

Using an interchange network 28, computers of merchant bank 26 may communicate with computers of an issuer bank 30 to determine whether account 32 of accountholder 22 is in good standing and whether the purchase is covered by an available credit line of the account 32 corresponding to accountholder 22. Based on these determinations, the request for authorization may be declined or accepted. If the request is accepted, an authorization code may be issued to merchant 24.

Merchants, such as merchant 24 may store payment card account information corresponding to one or more cardholders in a merchant account information data source 36. In certain embodiments, the merchant account information data source may be a local or remote database accessible by merchant 24. During a transaction, merchant 24 may retrieve account data from the merchant account information data source 36 as opposed to acquiring the information from accountholder 22, such as by having accountholder 22 provide his or her payment card account information by swiping a payment card or manually entering payment card information. So called “account-on-file” transactions may include recurring payments such as subscription fees, membership fees, electronic bills, and the like. Account-on-file transactions may also include instances when accountholder 22 is a repeat customer of merchant 24. Accordingly, account-on-file transactions generally require a cardholder to provide his or her payment card account information initially and then to authorize or enroll in an account-on-file service. Once enrolled or authorized, subsequent payments by accountholder 22 may be streamlined by either automatically charging accountholder 22 or by automatically retrieving account data corresponding to accountholder 22 from merchant account information data source 36.

For example, merchant 24 may be an internet service provider (ISP) that provides internet connectivity to accountholder 22 in exchange for a monthly service fee. Accountholder 22 may enroll in an automatic bill pay service with the ISP to pay for the monthly service charge. The ISP may store accountholder's 22 account data in an account information data source and submit the monthly service charges to issuing bank 30. As another example, merchant 24 may correspond with an online merchant from which accountholder 22 makes regular purchases. Accountholder 22 may create a user profile with the online merchant and provide his or her payment card account information, which the online merchant may then store in an account information data source. When accountholder 22 later logs onto the online merchant's website and selects goods or services for purchase, the online merchant may retrieve accountholder's 22 payment card account data and facilitate accountholder's 22 purchase by automatically populating purchase forms or performing similar steps with the retrieved account data.

Although account-on-file transactions provide improved efficiency for both merchants 24 and cardholders 22, payment card account information is subject to change. For example, a payment card's expiration date may lapse or issuer 30 may reissue a payment card with a different primary account number (PAN). If merchant 24 attempts to submit a transaction to issuer 30 for authorization after such a change and uses out-of-date account information, issuer 30 is likely to reject the transaction. Accordingly, regulated ABU computing device 34 may be implemented to ensure that account data maintained by merchant 24 is current. Specifically, regulated ABU computing device 34 may periodically receive payment card account data updates from one or more issuers, such as issuer 30, and store the received current payment card account data in an account information data source 38. Regulated ABU computing device 34 may then make the stored current payment card account data available to merchants 24 so that they may update their respective merchant account information data source 36.

In certain embodiments, account information data source 38 may store current payment card data for one or more cardholders, such as accountholder 22. For each payment card account of cardholder 22, account information data source 38 may include account data including, but not limited to, an account identifier such as a PAN, an expiration date, and a business identification number (BIN) identifying issuer 30. To facilitate locating current payment card account data, account information data source 38 may also store outdated account data in a manner that is linked to current account data. As a result, if an inquiry for current account data is submitted to regulated ABU computing device 34 using outdated payment card account data, regulated ABU computing device 34 may locate the corresponding current payment card account data in account information data source 38. For example, account information data source 38 may store both a current account identifier and one or more previous account identifiers associated with a payment card account of accountholder 22. Accordingly, if regulated ABU computing device 34 receives a request for account data including one of the previous account identifiers, regulated ABU computing device 34 may readily identify the corresponding current account identifier.

To obtain current account data, merchant 24 enrolls in payment platform 20 and submits an update request to regulated ABU computing device 34. The update request may include one or more account identifiers, such as PANs, corresponding to cardholders 22 for which merchant 24 is requesting current payment card account data. The update request may also include one or more merchant identifiers corresponding to which merchant 24 is requesting current payment card account data.

In response to the update request, regulated ABU computing device 34 may access payment card account data stored in account information data source 38 using the account identifier and verify the update request from merchant 24. Based on the verification, regulated ABU computing device 34 may determine that merchant 24 is verified and allow the update request, returning an update response containing the requested current payment card account data to merchant 24. Or, regulated ABU computing device 34 may determine that merchant 24 is non-verified and block the update request, returning an update request with a denial stating that the update request is blocked to merchant 24. The update response and/or update denial may also be sent to issuer 30 by regulated ABU computing device 34.

In certain embodiments, merchant bank 26 may accumulate update requests into a batch that is then submitted to regulated ABU computing device 34 for processing. In such embodiments, regulated ABU computing device 34 may transmit a response to each merchant 24 or may provide all relevant payment card account data as a batch in a single response to merchant bank 26. Merchant bank 26 may then distribute the payment card account data as required to each merchant 24 having previously submitted the update request.

Regulated ABU computing device 34 may verify the update request sent from merchant 24 by applying at least one verification rule derived from one or more data sets including account activity data, account fraud data, merchant activity data, and merchant fraud data stored in a fraud information data source 42, and determining that merchant 24 sending the update request is a verified merchant authorized to receive the current account data. Fraud information data source 42 generally stores information regarding at least one of account activity, merchant activity, and fraud activity. Fraud information may be received from one or more fraud monitoring sources, such as MasterCard System to Avoid Fraud Effectively (SAFE), MasterCard Expert Monitoring System (EMS), or any other fraud monitoring source.

For example, fraud information data source 42 may store account activity data. Account activity data may include one or more account identifiers and, for each account identifier, activity data, such as a date/time when each account identifier was last updated by regulated ABU computer device 34 and a list of merchants 24 who have submitted update requests related to the account identifier. Additionally, for each account identifier, fraud information data source 42 may further store account fraud data. For example, account fraud data may include account velocity data, such as one or more of a date/time of approved transactions, a date/time of chargeback per account, and an average transaction amount. Additionally, fraud information data source 42 may include an account identifier blacklist that restricts use of one or more account identifiers.

Fraud information data source 42 may also store merchant activity data. Merchant activity data may include one or more merchant identifiers and, for each merchant identifier, activity data. For example, fraud information data source 42 may include one or more of a date/time of the last update request received from merchant 24, and a date/time of the approved transactions for merchant 24. Additionally, for each merchant 24, fraud information data source 42 may further store merchant fraud data. For example, fraud data for merchant 24 may include merchant velocity data, such as one or more of a date/time of chargeback per merchant 24, per merchant category code, and per merchant county. Moreover, for each merchant 24, fraud information data source 42 may store merchant feedback data. For example, feedback data for merchant 24 may include feedback sent from issuer 30 to merchant 24 during transaction authorization requests. Additionally, fraud information data source 42 may include a merchant blacklist that restricts use for one or more merchants 24.

Based on the information stored in fraud information data source 42, regulated ABU computing device 34 may apply one or more verification rules to verify the update request submitted by merchant 24 and determine that merchant 24 is a verified merchant authorized to receive the current account data. The verification rules may be set by payment platform 20 to police the update requests sent by merchant 24 on behalf of issuer 30. For example, the verification rule may determine whether a predetermined merchant activity occurs, and if so, discontinue merchant 24 enrollment in the ABU system. The predetermined activity may be the update request history of merchant 24 that is stored in fraud information data source 42. If merchant 24 has no activity, for example no update requests, for a predetermined time period, for example six (6) months, regulated ABU computing device 34 may block the update request from merchant 24. Furthermore, regulated ABU computing device 34 may discontinue merchant 24 enrollment in the ABU system to block any further update requests from merchant 24. However, if merchant 24 has regular activity, for example, regularly submitting update requests and continuously processing payment transactions from accountholder 22, then regulated ABU computing device 34 may allow the update request and provide payment card account data to merchant 24.

Additionally or alternatively, issuer 30 may set the verification rules used by regulated ABU computing device 34. Issuer 30 may send and provide verification rules to an issuer rule information data source 44. Regulated ABU computing device 34 may then verify the update request from merchant 24 using the verification rules received from issuer 30 and stored in issuer rule information data source 44. As such, issuer 30 may have different verification rules for specific account ranges. For example, issuer 30 may provide a BIN with the payment card account data and use the BIN to identify high net worth accounts and average net worth accounts. Regulated ABU computing device 34 may select the verification rules used to verify the update request from merchant 24 from a set of verification rules based on the BIN. For example, issuer 30 may provide a more stringent set of verification rules for BINs identifying higher net worth accounts of accountholders 22 because they may be a larger target for fraudulent activity and/or have a higher account limit to draw from.

In certain embodiments, regulated ABU computing device 34 may verify the update request from merchant 24 using verification rules derived from the merchant activity data stored by fraud information data source 42. For example, on receipt of the update request from merchant 24, regulated ABU computing device 34 may verify the update request by determining whether merchant 24 has prior approved transactions, stored in fraud information data source 42, corresponding to accountholder's 22 payment card account data. If prior approved payment card transactions are not present between merchant 24 and accountholder 22, then regulated ABU computing device 34 may determine that merchant 24 is non-verified and block the update request from merchant 24. However, if prior approved payment card transactions are present between merchant 24 and accountholder 22, then regulated ABU computing device 34 may determine that merchant 24 is verified and allow the update request, providing the current payment card account data to merchant 24. In another example, regulated ABU computing device 34 may verify the update request from merchant 24 by determining whether the update request was received beyond a predefined time period since a last approved transaction corresponding to accountholder's 22 payment card account data. If the last approved transaction between merchant 24 and accountholder 22 occurred beyond a predetermined time period, for example twenty-four (24) months, from the update request, then regulated ABU computing device 34 may determine that merchant 24 is non-verified and block the update request from merchant 24. However, if the last approved transaction between merchant 24 and accountholder 22 occurred within the predetermined time period, then regulated ABU computing device 34 may determine that merchant 24 is verified and allow the update request, providing current payment card account data to merchant 24.

In other embodiments, regulated ABU computing device 34 may verify the update request from merchant 24 using verification rules derived from the merchant fraud data stored by fraud information data source 42. For example, on receipt of the update request from merchant 24, regulated ABU computing device 34 may verify the update request by determining whether a fraud chargeback count, derived from the merchant fraud data stored in fraud information data source 42, exceeds a predetermined fraud chargeback count limit. If the predetermined fraud chargeback count limit for merchant 24 is exceeded, then regulated ABU computing device 34 may determine that merchant 24 is non-verified and block the update request from merchant 24. However, if the predetermined fraud chargeback count limit for merchant 24 is not exceeded, then regulated ABU computing device 34 may determine that merchant 24 is verified and allow the update request, providing current payment card account data to merchant 24. In another example, regulated ABU computing device 34 may verify the update request by determining whether a fraud chargeback percentage, derived from the merchant fraud data stored in fraud information data source 42, exceeds a predetermined fraud chargeback percentage limit. If the predetermined fraud chargeback percentage limit for merchant 24 is exceeded, then regulated ABU computing device 34 may determine that merchant 24 is non-verified and block the update request from merchant 24. However, if the predetermined fraud chargeback percentage limit for merchant 24 is not exceeded, then regulated ABU computing device 34 may determine that merchant 24 is verified and allow the update request, providing current payment card account data to merchant 24. In a further example, regulated ABU computing device may verify the update request by determining whether merchant 24 is a common point of fraud that is derived from the merchant fraud data stored in fraud information data source 42. If merchant 24 is determined to be a common point of fraud, then regulated ABU computing device 34 may determine merchant 24 is non-verified and block the update request from merchant 24. However, if merchant 24 is not determined to be a common point of fraud, then regulated ABU computing device 34 may determine that merchant 24 is verified and allow the update request, providing current payment card account data to merchant 24.

Regulated ABU computing device 34 may also be configured to verify the update request from merchant 24 using verification rules derived from merchant feedback data stored by fraud information data source 42. During transaction authorization requests between issuer 30 and merchant 24, issuer 30 may include an advice code in the authorization response that provides instructions to merchant 24. For example, issuer 30 may request via DE48.84 that merchant 24 takes a particular action regarding the payment card account data, such as a stop to maintaining accountholder's 22 account-on-file information. Regulated ABU computer device 34 may record subsequent merchant 24 activities, such as the number of update requests for the payment card account data sent by merchant 24 after the stop instruction. As such, regulated ABU computing device 34 may look to the merchant feedback data to determine whether merchant 24 acted on the feedback data as an indicator of a non-fraudulent merchant 24.

For example, on receipt of the update request from merchant 24, regulated ABU computing device 34 may verify the update request by determining whether a feedback actioned count for merchant 24, derived from merchant feedback data stored by fraud information data source 42, exceeds a predetermined feedback actioned count limit. If the predetermined feedback actioned count limit for merchant 24 is exceeded, then regulated ABU computing device 34 may determine that merchant 24 is non-verified and block the update request from merchant 24. However, if the predetermined feedback actioned count limit for merchant 24 is not exceeded, then regulated ABU computing device 34 may determine that merchant 24 is verified and allow the update request, providing current payment card account data to merchant 24. In another example, regulated ABU computing device 34 may verify the update request by determining whether a feedback action percentage for merchant 24, derived from the merchant feedback data stored in fraud information data source 42, exceeds a predetermined feedback actioned percentage limit. If the predetermined feedback actioned percentage limit for merchant 24 is exceeded, then regulated ABU computing device 34 may determine that merchant 24 is non-verified and block the update request from merchant 24. However, if the predetermined feedback actioned percentage limit for merchant 24 is not exceeded, then regulated ABU computing device 34 may determine that merchant 24 is verified and allow the update request, providing current payment card account data to merchant 24.

In some embodiments, regulated ABU computing device 34 may verify the update request from merchant using verification rules derived from the merchant blacklist stored by fraud information data source 42. For example, regulated ABU computing device 34 may verify the update request from merchant 24 by determining whether merchant 24 is on the merchant blacklist. If merchant 24 is on the merchant blacklist, then regulated ABU computing device 34 may determine that merchant 24 is non-verified and block the update request from merchant 24. However, if merchant 24 is not on the merchant blacklist, then regulated ABU computing device 34 may determine that merchant 24 is verified and allow the update request, providing current payment card account data to merchant 24.

In certain embodiments, regulated ABU computing device 34 may also verify the update request from merchant 24 using verification rules derived from the account data corresponding to accountholder's 22 payment card and stored by fraud information data source 42. For example, on receipt of the update request from merchant 24, regulated ABU computing device 34 may verify the update request by determining whether the account identifier has a predetermined fraud indicator derived from the account fraud data, stored in fraud information data source 42. The fraud indicator may include one or more of determining whether a current payment card transaction by merchant 24 exceeds a previous spend history for the transaction type by accountholder 22, and determining whether account chargeback history exceeds an account chargeback limit. If the predetermined fraud indicators for accountholder's 22 payment card are present, then regulated ABU computing device 34 may determine that merchant 24 is non-verified and block the update request from merchant 24. However, if the predetermined fraud indicators for accountholder's 22 payment card are not present, then regulated ABU computing device 34 may determine that merchant 24 is verified and allow the update request, providing payment card account data to merchant 24.

In another example, regulated ABU computing device 34 may verify the update request from merchant 24 by determining whether the account identifier is on the account blacklist, stored in fraud information data source 42. If the account identifier is on the account blacklist, then regulated ABU computing device 34 may determine that merchant 24 is non-verified and block the update request from merchant 24. However, if the account identifier is not on the account blacklist, then regulated ABU computing device 34 may determine that merchant 24 is verified and allow the update request, providing current payment card account data to merchant 24. In a further example, regulated ABU computing device 34 may verify the update request from merchant 24 by determining whether a date of the account identifier exceeds a predetermined date limit. For example, if the account identifier provided by merchant 24 is more than the predetermined date limit, for example more than fifty (50) months old, then regulated ABU computing device 34 may determine that merchant 24 is non-verified and block the update request from merchant 24. However, if the account identifier provided by merchant 24 is less than the predetermined date limit, then regulated ABU computing device 34 may determine that merchant 24 is verified and allow the update request, providing current payment card account data to merchant 24.

### Example of an Account Billing Updater System

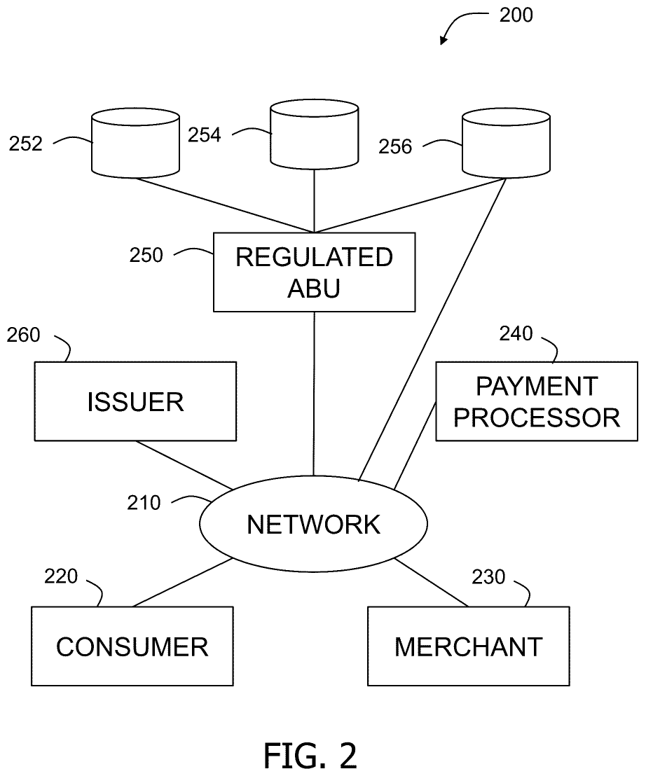

FIG. 2 is a diagram illustrating a regulated account-on-file billing updater (ABU) system 200 including a consumer, a merchant, a payment processor, an issuer, and an ABU, which may correspond to regulated ABU computing device 34 (shown in FIG. 1), in accordance with an example embodiment of the present disclosure.

Referring to FIG. 2, regulated ABU system 200 includes computing devices that respectively represent a consumer 220, a merchant 230, a payment processor 240, a regulated ABU 250, and an issuing bank (“issuer”) 260 which are connected to each other via network 210. Network 210 may include the Internet, the interchange network 28 of FIG. 1, and/or one or more other networks. For example, a connection between the computing devices may include a wireless network, a wired network, a telephone network, a cable network, a combination thereof, and the like. Examples of a wireless network include networks such as WiFi, WiMAX, WiBro, local area network, personal area network, metropolitan area network, cellular, Bluetooth, and the like.

Consumer 220 may be a computing device, for example, a mobile phone, a smart phone, a telephone, a computer, a laptop, a desktop, a tablet, an MP3 player, a digital assistant, a server, and the like. Consumer 220 may access a website that corresponds to or is hosted by the merchant 230, and/or may contact a phone number of merchant 230, and the like. Payment processor 240 may be a processing entity such as MASTERCARD®, VISA®, AMERICAN EXPRESS®, and the like. Issuer 260 may be a third-party bank that issued a payment card to a cardholder. For example, issuer 260 may correspond to payment processor 240.

Merchant 230 corresponds to a computing device configured to accept and process payment card transactions and to maintain a merchant account information data source, such as a database, that includes payment card account data associated with one or more cardholders. The merchant account information data source may be incorporated into merchant 230 or may be otherwise accessible by merchant 230 via a network, such as network 210. The information maintained in the merchant account information data source may generally be used to facilitate account-on-file transactions, such as automatic recurring payments.

Regulated ABU 250 is generally configured to receive account data from an issuing party, such as issuer 260, to store the account data, and to provide the account data to a requesting party, such as merchant 230. Regulated ABU 250 is further configured to verify an update request from the requesting party before providing the requested up-to-date account data.

Regulated ABU 250 may include or have access to one or more data sources to facilitate management of the ABU system 200. For example, in the embodiment of FIG. 2, regulated ABU 250 may have access to an account information data source 252, a fraud information data source 254, and an issuer rule information data source 256. Each of account information data source 252, fraud information data source 254, and issuer rule information data source 256 may be internal storage of regulated ABU 250 or may be remote to but accessible by regulated ABU 250. Each of account information data source 252, fraud information data source 254, and issuer rule information data source 256 may be stored on one or more data storage devices in one or more databases, tables, or similar storage structures.

Account information data source 252 contains account data received from one or more issuing parties, such as issuer 260. Account information data source 252 may be updated by regulated ABU 250 in response to receiving account data from issuer 260 over network 210. In certain embodiments, the account data may be sent by issuer 260 according to a predetermined schedule (e.g., daily, bi-weekly, etc.). In other embodiments, regulated ABU 250 may make a call to issuer 260 and account data may be sent by issuer 260 to regulated ABU 250 in response to the call. In still other embodiments, issuer 260 may automatically send account data to regulated ABU 250 upon changes to account data associated with one or more cardholders.

Regulated ABU 250 generally sends account data to requesting parties, such as merchant 230, upon receiving the update request. Update requests may be received over network 210 directly from merchant 230 or may be batched together by an acquirer, such as merchant bank 26 of FIG. 1, and transmitted to regulated ABU 250 in a batched format. Update requests generally include one or more account identifiers corresponding to payment card accounts for which the requesting party is requesting account data. In response to receiving an update request, regulated ABU 250 verifies the update request from the requesting party based on one or more verification rules. Based on the verification by regulated ABU 250 may determine that the merchant 230 is verified and allow the update request, retrieve the account data corresponding to the one or more account identifiers, and return an update response containing the requested payment card account data to the requesting party. Or, regulated ABU 250 may determine that the merchant 230 is non-verified and block the update request, returning an update response with a denial stating that the update request is blocked to the requesting party.

In conjunction with the update request, regulated ABU 250 may create an entry or update an existing entry in fraud information data source 254. Fraud information data source 254 generally stores account activity data, account fraud data, merchant activity data, and merchant fraud data corresponding to the validation rules for the update request verification. In certain embodiments, regulated ABU 250 may receive fraud data from one or more fraud monitoring sources, such as MasterCard System to Avoid Fraud Effectively (SAFE), MasterCard Expert Monitoring System (EMS), or any other fraud monitoring source, and store the data in fraud information data source 254.

Regulated ABU 250 may be configured to receive validation rules transmitted over network 210 by the issuer 260 to issuer rule information data source 256. For example, the issuer 260 may transmit validation rules to issuer rule information data source 256. In response, regulated ABU 250 receives the validation rules and applies the validation rules to verify the update request from merchant 230.

Regulated ABU 250 may also be configured to receive messages transmitted over network 210 during a payment card transaction. For example, in certain embodiments regulated ABU 250 may receive authorization messages such as authorization request messages sent from merchant 230 to issuer 260 and/or authorization response messages sent from issuer 260 to merchant 230. As regulated ABU 250 processes transaction messages, regulated ABU 250 may create or update entries in fraud information data source 254. In certain embodiments fraud information data source 254 may include entries corresponding to account-on-file transactions. For example, fraud information data source 254 may include one or more of a payment card number, a payment card expiration date, a merchant identifier, an amount, a date/time, a description of the goods/services purchased and the like. Regulated ABU 250 may also use fraud information data source 254 to track when feedback messages are included in the transaction messages. Accordingly, fraud information data source 254 may include an advice code field indicating one or more what type of feedback was transmitted to merchant 230 from issuer 260.

Regulated ABU 250 may be further configured to generate and transmit reports based on data stored in any of account information data source 252, fraud information data source 254, and issuer rule information data source 256. Reports may be generated and provided for one or more parties, including but not limited to issuers, cardholders, merchants, acquirers, and issuing banks, and may contain different data depending on the party for which the report is generated. For example, regulated ABU 250 may generate a report for an issuer that lists all merchants that had update requests blocked for specific accounts identifiers and the validation rule that blocked the request. For another example, regulated ABU 250 may generate a report for a merchant indicating if the merchant is on the blacklist.

Reports may take various forms. For example, in certain embodiments, reports generated by regulated ABU 250 may be created as a document in a markup language, such as extensible markup language (XML). In other embodiments, reports may be generated as messages that conform to one or more standards. Such standards may include, but are not limited to ISO 8583 and ISO 20022, which generally provide for the format and content of messages related to electronic transactions made by cardholders using payment cards and message transmitted between financial institutions, respectively. In still other embodiments, reports may be generated in a format compatible with and inserted into other messages transmitted over network 210. For example, regulated ABU 250 may generate a report suitable for insertion into an authentication request or response message sent between a merchant and an issuer over network 210.

### Example of a Regulated Abu Computing Device

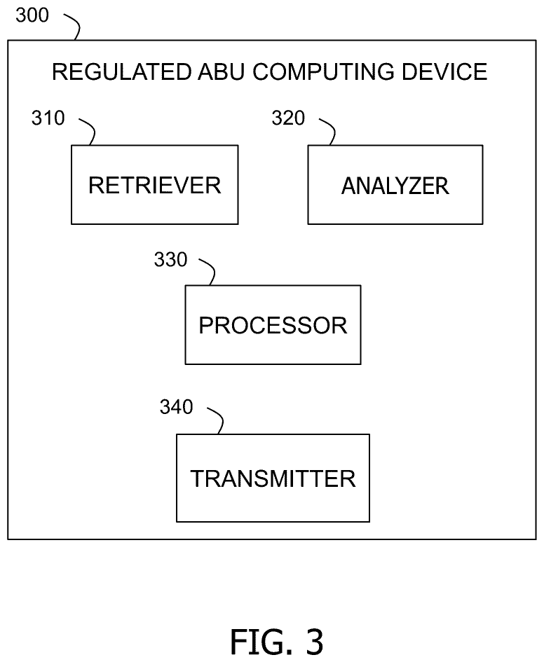

FIG. 3 is a diagram illustrating an example embodiment of a regulated account-on-file billing updater (ABU) computing device that may be included in the regulated ABU system of FIG. 2, in accordance with an example embodiment of the present disclosure.

Referring to FIG. 3, regulated ABU computing device 300 may correspond to device authenticator 250 shown in FIG. 2. Regulated ABU computing device 300 may be coupled to payment processor 240 or may be a separate computing device included in the system of FIG. 2, and may be connected to one or more of the other computing devices via the network 210. In this example, regulated ABU computing device 300 includes a receiver 310, an analyzer 320, a processor 330, and a transmitter 340. Regulated ABU computing device 300 may include additional components not shown, or less than the amount of components shown. Also, one or more of the components in this example may be combined or may be replaced by processor 330. The computer components described herein (e.g., receiver 310; analyzer 320; processor 330; and transmitter 340) may include hardware and/or software that are specially configured or programmed to perform the steps described herein.

Receiver 310 is generally configured to receive account data from one or more issuers, such as issuer 260 of FIG. 2. Such account data may include, but is not limited to, payment card account numbers, payment card account expiration dates, and the like. Receiver 310 may also be configured to retrieve account data from various data sources. For example, receiver 310 may receive account data from each of account information data source 252, fraud information data source 254, and issuer rule information data source 256 as depicted in FIG. 2. Receiver 310 may also be configured to receive update requests for account data stored in account information data source 252 from one or more requesting parties, such as a merchant. Receiver 310 may also be configured to receive fraud data stored in fraud information data source 254 from one or more fraud monitoring sources, such as MasterCard System to Avoid Fraud Effectively (SAFE), MasterCard Expert Monitoring System (EMS), or any other fraud monitoring source. Receiver 310 may also be configured to receive verification rules stored in issuer rule information data source 256 from an issuer. In certain embodiments, receiver 310 may also be configured to receive messages sent over an interchange network, such as network 210 of FIG. 2, which may include, but are not limited to, authorization request and response messages. Messages and account data received by receiver 310 may be in a batch format that aggregates multiple messages or data from multiple accounts. Accordingly, receiver 310 may be configured to parse individual messages and account data entries from such batched formats.

Analyzer 320 analyzes data and messages received through receiver 310. Analyzer 320 generally determines the type of data or message received and identifies how the data or message is to be processed by processor 330. In certain embodiments, analyzer 320 may determine whether data or messages received by receiver 310 include flags or other indicators that identify the type of data or message received by receiver 310. For example, the indicator may identify the message as one of an update request, fraud data, or a transaction-related message such as an authorization request or authorization response message.

After analysis by analyzer 320, processor 330 may further analyze and process data and messages received by receiver 310 and perform additional ABU-related functions.

In response to receiving an account data update from an issuing party, processor 330 may generally update an account information data source. For example, processor 330 may determine whether the account data update received from the issuing party includes account data corresponding to an account for which data is maintained in the account information data source. Processor 330 may also compare any existing data with that of the account data update to determine if any changes have occurred. Finally, processor 330 may add new entries to account information data source for any data corresponding to new accounts or overwrite any outdated data for existing accounts. Data recorded by processor 330 in account information data source may include, but is not limited to, an account number and an expiration date.

When updating existing records in the account information data source, processor 330 may also populate data fields or create records for the account data being overwritten. Such fields or records may be cross-referenced or otherwise linked to the corresponding updated account data received from the issuing party. Doing so permits regulated ABU computing device 300 to identify current account data corresponding to outdated account data that may be submitted by a requesting party.

In response to receiving an update request from a requesting party, processor 330 may validate the update request using at least one validation rule and determine that the merchant sending the update request is a verified merchant authorized to receive the current account data. More specifically, processor 330 may determine what account data is being requested and determine at least one verification rule to apply, apply the at least one verification rule, determine if the update request is verified, and generate an update response for transmission by transmitter 340.

In certain embodiments, processor 330 may select the verification rules from a set of verification rules based on a bank identification number (BIN) that is included in the account data. For example, the processor 330 may verify the update request by applying at least one verification rule for determining the verified merchant that includes at least one of determining that the merchant has prior approved transactions corresponding to the account identifier, and determining that the update request was received within a predetermined time period since a last approved transaction corresponding to the account identifier.

Processor 330 may verify the update request by applying at least one verification rule for determining the verified merchant derived from the merchant fraud data. For example, determining that a fraud chargeback count derived from the merchant fraud data is within a predetermined fraud chargeback count limit; determining that a fraud chargeback percentage derived from the merchant fraud data is within a predetermined fraud chargeback percentage limit; and determining that the merchant is not a common point of fraud.

In certain embodiments, processor 330 may verify the update request by applying at least one verification rule for determining the verified merchant derived from the account fraud data. For example, determining that the account identifier does not have predetermined fraud indicators derived from the account fraud data; determining that the account identifier is not on an account blacklist; and determining that a date of the account identifier is within a predetermined date limit.

Processor 330 may verify the update request by applying at least one verification rule for determining the verified merchant derived from the advice code data. For example, determining that a feedback actioned count derived from the advice code is within a predetermined feedback actioned count limit, and determining that a feedback actioned percentage derived from the advice code is within a predetermined feedback actioned percentage limit. In some embodiments, processor 330 may verify the update request by applying at least one verification rule for determining the verified merchant derived from the merchant blacklist, for example determining that the merchant is not on the merchant black list.

In addition to processing requested account data, processor 330 may also create or update entries in a fraud information data source. The fraud information data source may generally store information regarding account and/or merchant activity. Accordingly, for one or more payment card accounts processor 330 may create or modify records in the fraud information data source indicating account activity data and/or account fraud data. Additionally, for one or more merchant identifier processor 330 may create or modify records in the fraud information data source indicating merchant activity data and/or merchant fraud data.

Processor 330 may also be configured to process verification rules corresponding to the issuer's verification rules within issuer rule information data source. Additionally, processor may generate update responses containing or based on data from one or more of the account information data source, the fraud information data source, and the issuer rule information data source.

In certain embodiments, regulated ABU computing device 300 may also include a transmitter 340 for transmitting data, including, but not limited to update response messages and requests/queries for account data from one or more of an account information data source, a fraud information data source, and an issuer rule information data source.

### Example Methods for Regulating Account-on-File Information

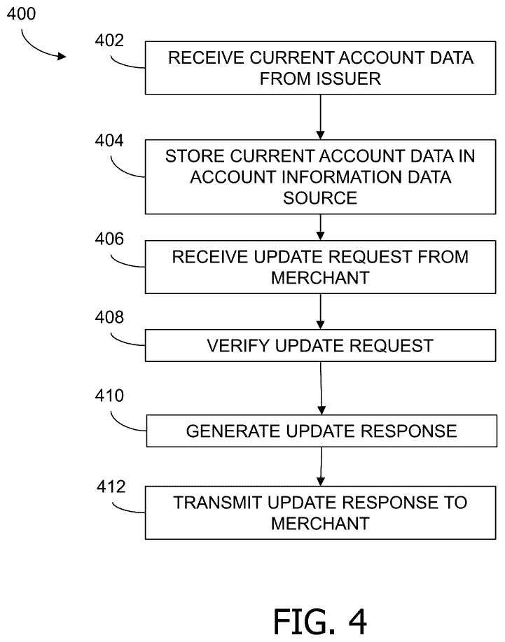

FIG. 4 is a diagram illustrating an example of a method 400 for verifying account-on-file information that may be performed by a regulated account-on-file billing updater (ABU) computing device in communication with at least one memory device, such as regulated ABU computing device 300 of FIG. 3.

Initially, the regulated ABU computing device receives current account data from an issuer 402, which may be an issuing bank. The current account data may correspond to a cardholder, such as an accountholder. The regulated ABU computing device may request the current account data from the issuer, or the issuer may transmit the current account data to the regulated ABU computing device without a request.

The regulated ABU computing device may then store the current account data in an account information data source 404 based on an account identifier associated with the cardholder. Storing the current account data in the account information data source may include creating new entries or overwriting existing entries in the account information data source. Storing the current account data may also include updating corresponding data fields such as a last date/time updated and/or outdated account data.

The regulated ABU computing device may receive an update request from a merchant 406. The update request may include the account identifier and request the current account data of the cardholder. In response to the update request, the regulated ABU computing device may verify the update request 408 by applying at least one verification rule and determining that the merchant sending the update request is a verified merchant authorized to receive the current account data.

In certain embodiments, the regulated ABU computing device may select the verification rules from a set of verification rules based on a bank identification number (BIN) that is included in the account data. For example, the regulated ABU computing device may verify the update request by applying at least one verification rule that includes at least one of determining that the merchant has prior approved transactions corresponding to the account identifier, and determining that the update request was received within a predetermined time period since a last approved transaction corresponding to the account identifier.

The regulated ABU computing device may also receive merchant fraud data from a from a fraud monitoring source and verify the update request by applying at least one verification rule for determining the verified merchant derived from the merchant fraud data. For example, determining that a fraud chargeback count derived from the merchant fraud data is within a predetermined fraud chargeback count limit; determining that a fraud chargeback percentage derived from the merchant fraud data is within a predetermined fraud chargeback percentage limit; and determining that the merchant is not a common point of fraud.

In certain embodiments, the regulated ABU computing device may receive account fraud data from the fraud monitoring source and verify the update request by applying at least one verification rule for determining the verified merchant derived from the account fraud data. For example, determining that the account identifier does not have predetermined fraud indicators derived from the account fraud data; determining that the account identifier is not on an account blacklist; and determining that a date of the account identifier is within a predetermined date limit.

The regulated ABU computing device may also receive an advice code corresponding to a payment card transaction response between the issuer and the merchant and store the advice code. Verifying the update request may occur by applying at least one verification rule for determining the verified merchant derived from the advice code data. For example, determining that a feedback actioned count derived from the advice code is within a predetermined feedback actioned count limit, and determining that a feedback actioned percentage derived from the advice code is within a predetermined feedback actioned percentage limit.

In some embodiments, the regulated ABU computing device may receive a merchant blacklist and verify the update request by applying at least one verification rule for determining the verified merchant derived from the merchant blacklist, for example, determining that the merchant is not on the merchant black list. In other embodiments, the regulated ABU computing device may receive the verification rules from the issuer.

Based on the verification of the update request the regulated ABU computing device may generate an update response 410. The regulated ABU computing device may determine that the merchant is verified and allow the merchant update request, returning an update response containing the current account data, or the regulated ABU computing device may determine that the merchant is non-verified and block the merchant update request, generating the update response denying the update request. Once generated, the regulated ABU computing device may transmit the update response to the merchant 412.

In certain embodiments, the regulated ABU computing device may also transmit the update response to the issuer. While in other embodiments, the ABU computing device may discontinue merchant enrolment in an ABU system if a predetermined activity occurs. For example, if the merchant has not participated in the ABU system for a time period of six (6) months.

### Additional Considerations

Computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the terms “card,” “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transaction card can be used as a method of payment for performing a transaction. In addition, consumer card account behavior can include, but is not limited to, purchases, management activities (e.g., balance checking), bill payments, achievement of targets (meeting account balance goals, paying bills on time), and/or product registrations (e.g., mobile application downloads).

For example, one or more computer-readable storage media may include computer-executable instructions embodied thereon for regulating account-on-file information. In this example, the computing device may include a memory device and a processor in communication with the memory device, and when executed by said processor, the computer-executable instructions may cause the processor to perform a method, such as the methods described and illustrated in the examples of FIG. 4.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example, the system is executed on a single computer system, without a connection to a server computer. In a further example, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computing system for controlling automatic transmission of updated data files to a requesting third-party by verifying the requesting third-party, the computing system comprising one or more processors in communication with one or more memory devices, the one or more processors programmed to:
receive an updated data file from a first remote computing device associated with a verified issuer of the updated data file, the updated data file corresponding to an accountholder and comprising an update to at least one data element of a plurality of data elements included within the updated data file;
store the updated data file in a secure data store based on a unique identifier;
store in the one or more memory device at least one verification rule including one or more conditions for verifying a requesting third-party as a legitimate receiving party before transmitting the updated data file to the then verified third-party;
monitor network traffic of a processing network for the processing of data associated with the updated data file by an identified third-party processed within a predefined period of time;
in response to detecting the processing of data associated with the updated data file by the identified third-party over the processing network, create an additional verification rule for the identified third-party;
receive a query for an updated data file query from a third-party computing device of a candidate requesting third-party, the query including the unique identifier for a corresponding updated data file and a request of the updated data file;
apply the at least one verification rule to the query and the candidate requesting third-party;
apply the additional verification rule to the candidate requesting third-party to confirm that the candidate requesting third-party has been identified as processing data associated with the requested updated data file over the processing network within the predefined period of time thereby verifying the candidate third-party as a legitimate receiving party of the requested updated data file; and
in response to verifying the candidate third-party as the legitimate receiving party, automatically transmit the requested updated data file to the verified requesting third-party thereby ensuring data security including that the legitimate third-party is receiving the updated data file before the updated data file is transmitted thereto.
